(19) United States
(12) Patent Application Publication
(10) Pub. No.: US 2010/0103197 A1
(43) Pub. Date: Apr. 29, 2010

(54) METHOD FOR ADJUSTING FONT SIZE ON SCREEN

(75) Inventor: QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/464,514

(22) Filed: May 12, 2009

(30) Foreign Application Priority Data
Oct. 27, 2008 (CN) 200810305230.3

(51) Int. Cl. G09G 5/26

(52) U.S. Cl. 345/660

(57) ABSTRACT

A method for adjusting a font size on a screen is disclosed. The method includes: establishing a relationship between reading distances and font sizes. When the reading distance is decreased, the font size is increased. The distance is determined by detecting a real reading distance from the screen. A character with the corresponding font size on the screen is shown according to the real reading distance.

### BACKGROUND

1. Technical Field

The present disclosure relates to a method for adjusting a font size of a character displayed on a screen.

2. Description of Related Art

Generally, a mobile terminal includes a screen for communicating with a user. A font size of a character displayed on the screen is usually unchangeable. When the font size is too small, the user has to move their eyes close to the screen of the mobile terminal for reading the character clearly, and even then may not be clear for those with poor eyesight.

What is needed, therefore, is a method for adjusting a font size of a character displayed on a screen automatically according to a reading distance between a user and the screen.

### BRIEF DESCRIPTION OF THE DRAWINGS

FIG. 1 is a schematic diagram of an embodiment of a method for adjusting a font size on a screen used in a mobile terminal in one state.

FIG. 2 is similar to FIG. 1 but showing another state.

FIG. 3 is a flow chart for setting a default font size in the method for adjusting font size on the screen.

FIG. 4 is a flow chart of the method for adjusting font size on the screen.

### DETAILED DESCRIPTION

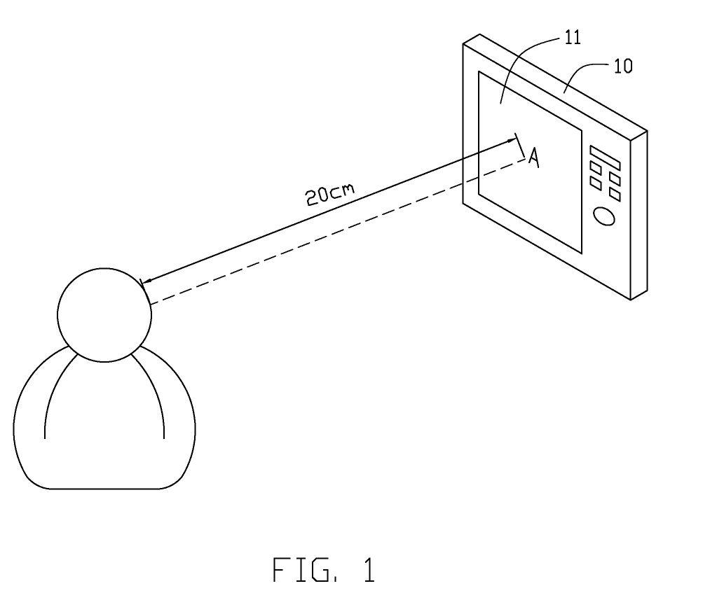

Referring to FIG. 1, an embodiment of a method for adjusting font size of a character displayed on a screen is used in a mobile terminal 10. A character database having a plurality of characters is stored in the mobile terminal 10, and the mobile terminal 10 includes a screen 11 for displaying character in the character database. A distance detecting device is installed in the mobile terminal 10 for detecting a distance between eyes of a user and the screen 11 of the mobile terminal 10. Distance detecting technologies such as ultrasonic, infrared, and lasers can be used.

A plurality of font size numbers F1, F2, F3, . . . , Fn of characters are defined in the character database before using the mobile terminal 10, and F1 is configured to a smallest font size, Fn is configured to a largest font size. The font size number F1 corresponds to a normal reading distance between the eyes of the user and the screen 11 of the mobile terminal 10 detected by the distance detecting device. For example, representing a current reading distance as X, and defining normal reading distance as 20 centimeters (cm), when X is equal to 20 centimeters, the font size F1 will be used.

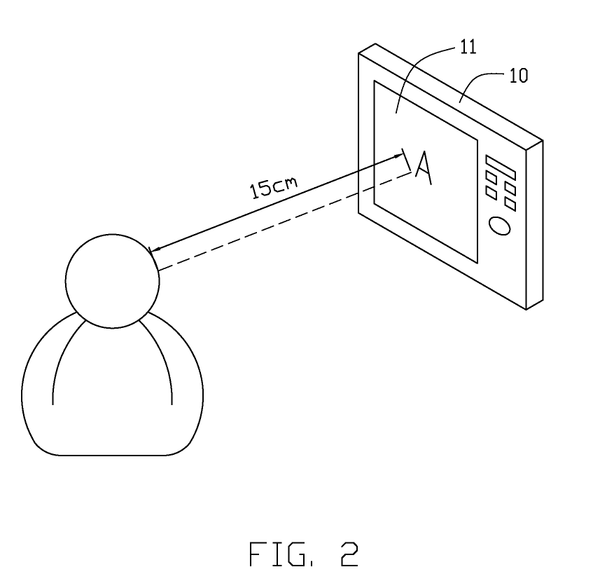

Referring to FIG. 2, when the current reading distance X is less than the normal distance, a larger font size will be used. For example, when the current reading distance X is 15 centimeters, the font size F2, which is larger than F1, will be used. Therefore, a relationship table between the reading distance X (cm) and the font size of the character displayed on the screen 11 can be set as follows:

| | X (cm) | | | | |
|---|---|---|---|---|---|
| | X ≧ 20 | 15 ≦ X < 20 | 10 ≦ X < 15 | 5 ≦ X < 10 | X < 5 |
| Font Size | F1 | F2 | F3 | F4 | F5 |

In the above table, 20 centimeters is regarded as the normal reading distance, and the font size number F1 is the default font size. The normal reading distance and the default font size of the character can be set arbitrarily according to the requirements of the user. The intervals of the reading distances in the relationship table can also be set arbitrarily.

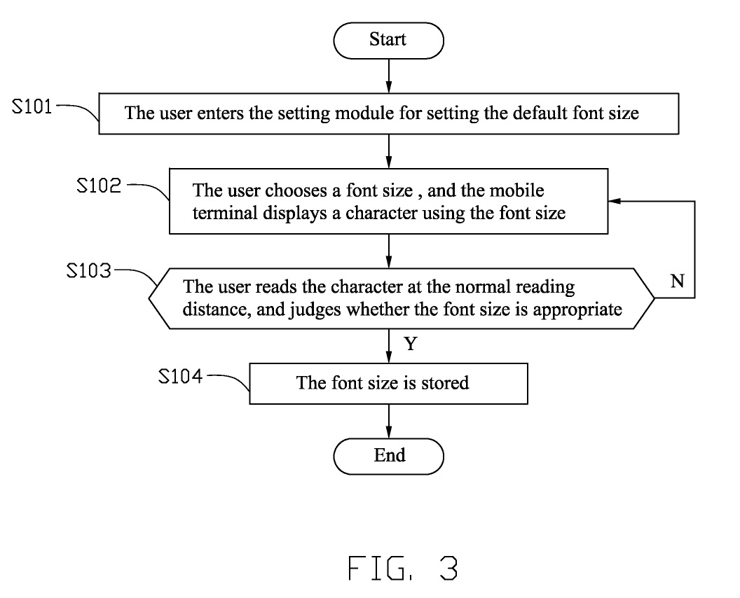

Referring to FIG. 3, a flow chart for setting a default font size of the character according to the requirement of the user includes the following steps:
S101: The user enters the setting module of the mobile terminal 10 for setting the default font size;
S102: The user chooses a font size, and the mobile terminal 10 displays a character using the font size;
S103: The user reads the character displayed on the screen 11 of the mobile terminal 10 at their normal reading distance, and judges whether the font size of the character is appropriate; if appropriate, go to next step S104; if not, switch back to step S102;
S104: The font size of the character chosen by the user is stored in the mobile terminal 10 as the default font size, and the process ends.

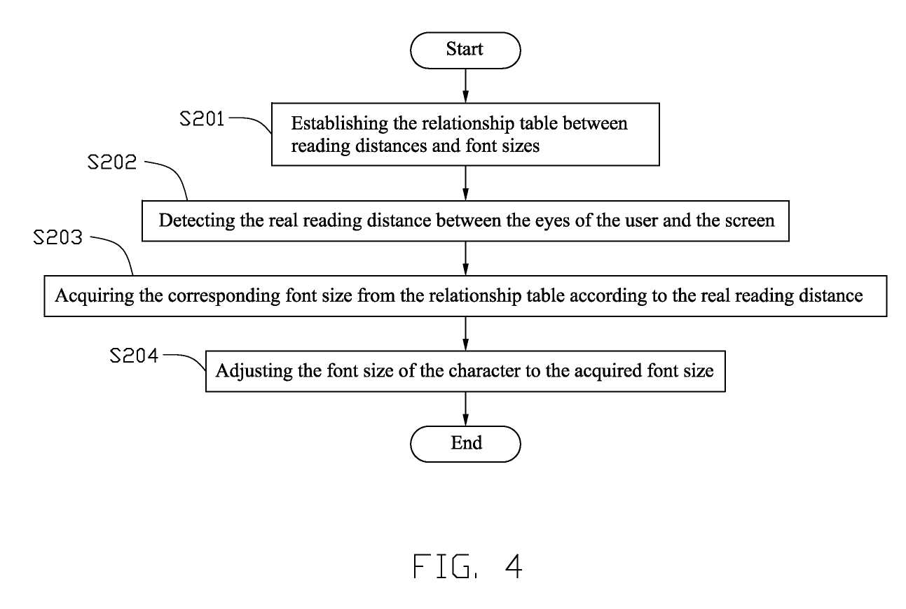

Referring to FIG. 4, a flow chart of the method for automatically adjusting a font size on the screen 11 includes the following steps:
S201: Establishing a relationship table between reading distances and font sizes according to the setting of the default font size by the user, when the reading distance between the user and the screen 11 is decreased, the font size of the character displayed on the screen 11 will be increased;
S202: Detecting a real reading distance between the eyes of the user and the screen 11 of the mobile terminal 10 through the distance detecting device;
S203: Acquiring the corresponding font size from the relationship table according to the real reading distance detected by the distance detecting device;
S204: Adjusting the font size of the character displayed on the mobile terminal 10 to the acquired font size. When the user moves closer to the mobile terminal 10, the font size of the character displayed on the screen 11 will be increased automatically.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for adjusting a font size on a screen, comprising:
establishing a relationship between reading distances and font sizes, the reading distance being decreased, the font size being increased;
detecting a real reading distance from the screen; and
displaying a character with the corresponding font size on the screen according to the real reading distance.

2. The method of claim 1, wherein detecting the real reading distance from the screen utilizes the ultrasonic, infrared, or laser means.

3. The method of claim 1, further comprising:
setting a default font size for a normal reading distance in front of the screen, and establishing a relationship between the default font size and the normal reading distance.

4. The method of claim 3, wherein setting the default font size of the normal reading distance comprises:
choosing a font size, and displaying a character with the font size on the screen;
reading the character displayed on the screen at the normal reading distance, and judging whether the size of the character is appropriate; and
if it is appropriate, storing the font size.

5. The method of claim 4, wherein if the font size of the character is not appropriate, choosing another font size until the font size being chose is appropriate, and then storing the font size.

6. The method of claim 1, wherein the reading distance is a straight distance between the eyes of a user and the screen.

7. A method for adjusting a font size of a character displayed on a screen, comprising:
detecting a real reading distance between a user and the screen;
enlarging the font size when the real reading distance is decreased.

8. The method of claim 7, wherein detecting the real reading distance between the user and the screen utilizes ultrasonic, infrared, or laser means.

9. The method of claim 7, further comprising:
establishing a relationship between reading distances and font sizes, such that when the reading distance is decreased, the font size is increased.

10. The method of claim 9, further comprising:
setting a default font size for a normal reading distance between the user and the screen, and establishing a relationship between the default font size and the normal reading distance.

11. The method of claim 10, wherein setting the default font size of the normal reading distance comprises:
choosing a font size, and displaying a character with the font size on the screen;
reading the character displayed on the screen at the normal reading distance, and judging whether the font size is appropriate; and
if it is appropriate, set and storing the font size.

12. The method of claim 11, wherein if the font size is not appropriate, choosing another font size.

13. The method of claim 9, wherein the reading distance is a straight distance between the eyes of the user and the screen.
